(19) United States
(12) Patent Application Publication
(10) Pub. No.: US 2017/0050331 A1
(43) Pub. Date: Feb. 23, 2017

(54) GRIPPER COMPRISING AN ULTRASONIC SENSOR

(71) Applicant: GEA Food Solutions Germany GmbH, Biedenkopf-Wallau (DE)

(72) Inventor: Bernd Fischl, Altusried / OT Krugzell (DE)

(21) Appl. No.: 15/303,267

(22) PCT Filed: May 5, 2015
(86) PCT No.: PCT/EP2015/059810

§ 371 Date: Oct. 11, 2016

(30) Foreign Application Priority Data
May 8, 2014 (DE) 10 2014 208 670.1

(51) Int. Cl. B26D 5/28; A22C 17/02; A22C 17/00; B26D 7/06; B26D 7/01

(52) U.S. Cl. CPC B26D 5/28; B26D 7/0633; B26D 7/01; A22C 17/0033; A22C 17/02; B26D 2007/011; B26D 2210/02

(57) ABSTRACT

The invention relates to a device for slicing one or more food products, in particular sausage, ham, and/or cheese, wherein a track is provided for each food product, along which track the food product is transported in the direction of a moving blade, which cuts off food slices from the front end of the food product.

The present invention relates to a device for slicing one or more food product(s), in particular sausage, ham and/or cheese, wherein for each food product is respectively provided a track along which it is transported in the direction of a moving blade which cuts off food slices from the front end of the food product, wherein the device has a gripper which grips the back of the food product before or during the slicing. The present invention additionally relates to a method for slicing a food product.

Devices of this type are well known from the prior art. In addition, it is known, for instance from WO2010/011237 A1 DE 30 10 732 A1, WO 2004/106 020 A1, DE 10 2009 023 749 A1, to equip the gripper with a sensor. The sensors which are described there are, however, comparatively complex in their manufacture, in their installation and/or in their operation.

The object of the present invention was therefore to provide a device or a method which does not have the drawbacks of the prior art.

The object is achieved with a device for slicing one or more food product(s), in particular sausage, ham and/or cheese, wherein for each food product is respectively provided a track along which it is transported in the direction of a moving blade which cuts off food slices from the front end of the food product, wherein the device has a gripper which grips the back of the food product before or during the slicing, and the gripper has an ultrasonic sensor.

The statements made about this subject of the present invention apply equally to the other subjects of the present invention, and vice versa.

The present invention relates to a device for slicing food products, such as, for instance, sausage, ham and/or cheese. Slicing devices of this type are also referred to by the person skilled in the ant as “slicers” or “high-performance slicers”. These slicing devices have a moving, in particular rotating, cutting blade, which cuts off food slices from the front end of a food product. The cutting blade here rotates at up to 1,000 revolutions per minute and more and/or cooperates with a cutting edge, which is provided, for instance, at the front end of a product support and which jointly with the blade defines the cutting plane in which food slices are cut off from the food product. Between the cutting blade and the cutting edge is found a cutting gap, which should be as small as possible in order to prevent parts of the food product from being “chopped off”. The cutting gap must however be sufficiently large that the blade, as far as possible, does not touch the cutting edge. During the slicing, the food product is transported continuously or intermittently in the direction of the cutting blade. After a slice has been cut off from the respective food product, the cutting blade disengages from the respective food product, so as then to penetrate afresh into the food product and cut off the next food slice. The advance of the respective food product between two cuts determines the thickness of the respectively cut-off food slice. The cut-off food slices fall, for instance, onto a depositing table, on which they can be combined into portions. As soon as a portion is finished, it is removed from the discharge region of the blade and the cut-up of a new portion can begin. Before the start of or during the slicing of the food product, its rear end is respectively gripped by a gripper, for instance in order to stabilize the food product in particular toward the end of the slicing and/or to dispose of the remaining remnant, gripped by a gripper. Each gripper has a drive with which it is movable, for instance, out of a starting position, in particular parallel to the direction of transport of the food product during the slicing, in the direction of the back of the product, in order to be brought into engagement with said back. Preferably, the gripper has a means, for instance nippers and/or a vacuum means, to reversibly produce a form closure and/or force closure between the gripper and the food product. Once the slicing of the respective food product is ended, the connection between the gripper and the remaining end piece is released and the end piece falls, for instance, into a chute, in particular after it has been withdrawn from the cutting plane by the gripper. After this, the gripper generally travels into a standby position, from which it is then moved again in the direction of the back of the food product in order to grip a new food product. Preferably, the slicing device is of multitrack design, that is to say that a plurality of food products are sliced by one blade, in particular at least partially simultaneously or at least partially sequentially. For this, the device has for each food product an own track along which it is transported in the direction of the blade. In each track is provided a gripper, the drive of which can preferably in each case be individually regulated. The grippers can be provided on a mobile central unit, relative to which they are then provided to be respectively movable.

According to the invention, the gripper is provided with an ultrasonic sensor. In particular, the ultrasonic sensor is provided in the region of a contact surface against which the rear end of the food product bears after the gripper has gripped it. The ultrasonic sensor generates a signal, which is sent, in particular, to the control/regulating system of the device according to the invention and which regulates/controls, inter alia, the drive which moves the gripper in the direction of the back of the food product. For instance, the path to be covered, the speed and/or the acceleration of the gripper is regulated. Preferably, the generation of a signal of the ultrasonic sensor takes place repeatedly while the gripper moves in the direction of the rear end of the food product. Preferably, the frequency and/or amplitude of the ultrasonic sensor can be altered, for instance, by the regulating/control system, for instance can be altered in a manner dependent on the food product, in order to obtain a distance signal which is as accurate as possible.

Preferably, the movement of the gripper is regulated such that the food product, when it comes into contact with the gripper and/or is gripped, is not, or is only comparatively little compressed. This preferred embodiment of the present invention has the advantage that the shape and/or the position of the food product upon the contact with the gripper is not, or is only comparatively slightly altered, so that corresponding data which are determined before and/or during the slicing do not, or only slightly alter.

Preferably, the ultrasonic sensor determines the distance between the gripper and the back of the food product. This can happen before and/or during the movement of the gripper in the direction of the back of the food product. Preferably, the determination of the distance of the gripper to the back of the food takes place repeatedly, in particular at regular time intervals and/or physical spacings, in particular up to the moment at which the gripper touches or almost touches the food product. After each measurement, the ultrasonic sensor sends a signal to a regulating/control system of the device according to the invention, so that this, at least at regular time intervals and/or physical spacings, preferably constantly, knows how large is the distance between the gripper and the back of the food product.

The signal produced by the ultrasonic sensor is preferably used to regulate or to control the drive which moves the gripper in the direction of the back of the food product, in particular the speed thereof and/or the path thereof. Preferably, the regulation is realized such that the gripper does not alter, or only very slightly alters the food product in its shape and/or position. This can be done, for instance, by virtue of the fact that the speed of the gripper, during and/or before the touching of the food product, is low, and/or that the gripper is abruptly halted as soon as a predefined distance between the gripper and the back of the food product is fallen below.

Further preferredly, the gripper has a further drive, which reversibly effects or lifts the form closure and/or force closure between the gripper and the food product. This drive actuates, for instance, the nipper of the gripper, which nipper, in the gripping process, penetrates into the food product, and/or the drive is, for instance, a means which produces a vacuum in the region of the contact surface of the gripper, which vacuum draws the rear end of the food product to the contact surface of the gripper and/or adheres it thereto. Preferably, this drive is likewise controlled or regulated on the basis of the signal of the ultrasonic sensor, so that the form closure and/or force closure is realized at a quite specific moment or at a certain distance between gripper and back of the food product, and/or is also realized such that the gripper grips the food product securely, yet deforms it as slightly as possible during the gripping.

Should the back of the food product not be flat, the ultrasonic sensor preferably determines the distance between that section of the back of the food product which lies closest to the gripper and the contact surface of the gripper. Alternatively or additionally, a profile of the back of the food product is created with the ultrasonic sensor and the distance between food product and gripper is determined on the basis of this profile.

Preferably, the device has a plurality of tracks, in each of which, in particular independently of the other tracks, a food product is sliceable, wherein each track has a gripper, which can respectively be brought into engagement with the back of the respective food product, preferably independently of the other grippers. The cut-up in the tracks can be realized simultaneously and/or sequentially. The same or different food products can be sliced simultaneously. The tracks can be loaded simultaneously and/or one after another. Preferably, each track has a chute into which the respective remnant can be discharged. The release of the remnants can be realized simultaneously or sequentially.

Preferably, on the basis of the signal of the ultrasonic sensor, it can be determined whether a food product is present in the respective track. Further preferredly, with the ultrasonic sensor the length of the respective product can be determined, in particular when this, for instance, bears against a reference point, for instance a slide.

According to a preferred embodiment of the present invention, the gripper has an ejector for the remnant of the food product, and the ultrasonic sensor checks whether the remnant is actually ejected, in particular after the ejector has been actuated. This preferred embodiment has the advantage that it is ensured that the gripper is not blocked with a remnant when it is due to grip a new food product.

A further subject of the present invention is a method for slicing a food product with the device according to the invention, in which the ultrasonic sensor determines the distance between the gripper and the back of the food product and a regulating system regulates or controls the drive of the gripper, which moves the gripper in the direction of the back of the food product, in dependence on the signal of the ultrasonic sensor.

The statements made about this subject of the present invention apply equally to the other subjects of the present invention, and vice versa.

Preferably, the path which the gripper is intended to cover, and/or its speed, is regulated or controlled. Preferably, during the movement of the gripper further signals of the ultrasonic sensor are processed by the regulating system and used for a desired/actual comparison, in order to establish whether the gripper has covered the desired path and/or has the desired speed. Preferably, the speed is corrected on the basis of the desired/actual comparison, where necessary. Preferably, the speed of the gripper is reduced as soon as it is close to the back of the food product. The gripping can take place before the start of the slicing of the respective food product or after its cut-up has already begun. In the latter case, the movement of the back of the food product is preferably taken into account, where necessary, in the regulation/controlling of the movement of the gripper. The same preferably applies to the activation of the form closure and/or force closure means of the gripper.

According to a further inventive or preferred subject of the present invention, on the basis of the signal of the ultrasonic sensor, it is determined whether a food product is present in the respective track.

The statements made about this subject of the present invention apply equally to the other subjects of the present invention, and vice versa.

If the ultrasonic sensor cannot detect a food product in the respective track, the control/regulating system of the device preferably emits an appropriate signal and/or a process initiated to stop the device and/or load the appropriate track.

According to yet another preferred or inventive subject of the present invention, the remnant, after the slicing of the food product, is released, in particular offloaded by the gripper, wherein, on the basis of the signal of the ultrasonic sensor, it is determined whether the release/offloading has actually taken place.

The statements made about this subject of the present invention poly equally to the other subjects of the present invention, and vice versa.

According to yet another inventive or preferred subject of the present invention, the position of the gripper after the gripping of the product is used to regulate the slicing of the food product.

The statements made about this subject of the present invention apply equally to the other subjects of the present invention, and vice versa.

On the basis of the position of the gripper, the device knows, for instance, how far the slicing process has progressed and can control or regulate this process accordingly. The position of the gripper can also be used for the slicing of weight-accurate portions.

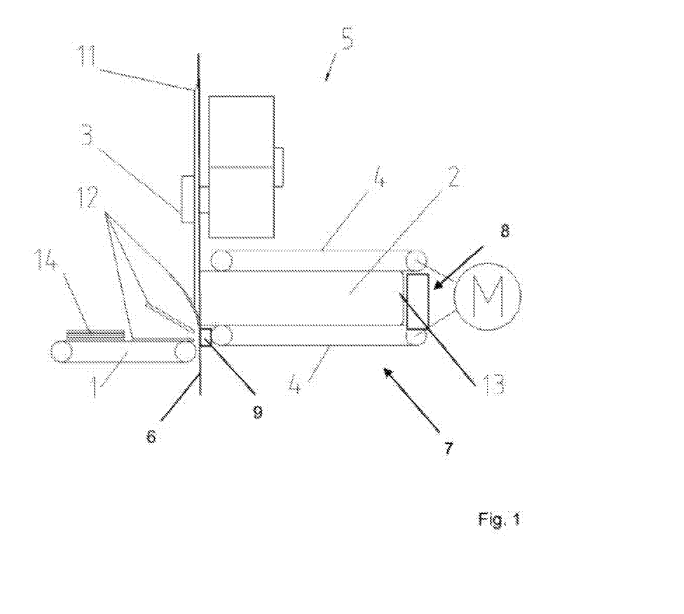

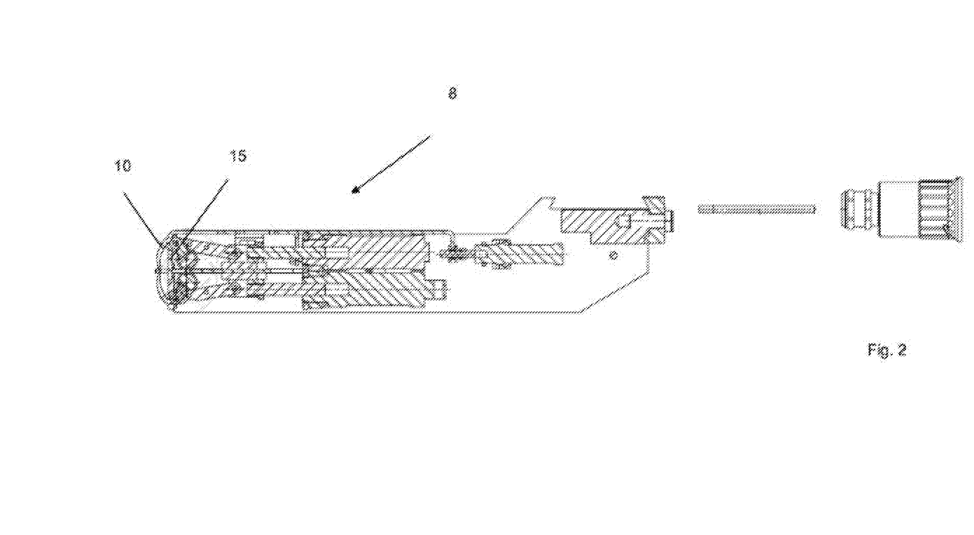

In the following the invention is explained on the basis of FIGS. 1 and 2. These comments are merely exemplary and do not restrict the general inventive concept. The comments apply equally to all subjects of the present invention.

FIG. 1 shows the slicing device according to the invention.

FIG. 2 shows the gripper of the slicing device.

FIG. 1 shows a slicing device o according to the invention. The slicing device 5 has a cutting blade 11, which cuts a food product 2 into food slices 12. To this end, each food product 2 is transported with a conveying means 4, here two conveyor belts 4, continuously or intermittently in the direction of the cutting plane 6 of the blade 11. The lower conveyor belt 4 is at the same time a product support. The cutting blade 11 is fastened to a rotating blade holder 3 and cooperates in cutting arrangement with a cutting edge 9, which is provided, for instance, at the front end of a product support 4 and which, jointly with the cutting blade, defines the cutting plane 6. Present between the blade Ii and the cutting edge 9 is a so-called cutting gap, which should be as small as possible, yet sufficiently large that the blade does not touch the cutting edge. This cutting gap must be regularly adjusted. This can be realized by a movement of the blade and/or of the cutting edge. Moreover, the cutting edge must be oriented parallel to the blade. After having been cut off, the food slices generally fall onto a depositing table 1, which is provided with transport means, for instance conveyor or transport belt, on which they are configured to form respectively a portion 14, here a stack. The finished portions 14 are then evacuated from the cutting blade region and afterward packed. Under the transport means of the depositing table can be provided an underlying sheet, which in particular prevents an excessive elongation of the transport means. The slice thickness derives from the length of feed of the food product between two cuts. At constant blade rotation speed, the regulation of the slice thickness is realized via the feed rate of the food product The slicing device has per feed line a gripper 8, which grips the rear end 13 of the food product 2 before or during the slicing and stabilizes it during the slicing, in particular toward the end of the slicing, and disposes of the end piece, which cannot be sliced. Each gripper is preferably provided on a gripper carriage (not represented), which moves the gripper forward and back, in particular parallel to the direction of feed of the food product. The gripper 8 preferably has a contact surface for the back of the food product and/or nippers 10, which are movably provided to reversibly penetrate into the food product and thereby produce a form and/or force closure between the gripper and the food product.

FIG. 2 shows the nippers 10 in their closed, i.e. gripping position. Before or after the start of the slicing, the gripper is brought into engagement with the back, i.e. the end lying opposite the front end, of the food product. For this, the gripper is moved, for instance out of a position in which it is found during the loading of the device, by a drive in the direction of the back of the food product. According to the invention, the gripper now has an ultrasonic sensor, which is preferably located in the region of the contact surface of the back of the food product and, on the basis of its signal, the distance between the gripper, in particular the ultrasonic sensor, and the back of the food product is determined. This distance measurement can be made one or more times. The time intervals and/or physical spacings at which a measurement is made can be equidistant or different. For instance, the frequency of the measurements can increase when the gripper gets close to the back of the food product. On the basis of the measurement(s), the movement of the gripper in the direction of the back of the food product is controlled and/or regulated. The regulation is here realized in particular such that the food product, upon the contact with the gripper, is altered as slightly as possible, preferably not at all in its shape, i.e. for instance compressed, and/or in its position, for instance pushed in the direction of the cutting blade. The ultrasonic sensor can also be used to check whether a food product is present in the respective track, and/or whether, after the end of the slicing, the remaining remnant has been successfully discharged.

Preferably, the slicing device is of multitrack design, that is to say that a plurality of food products 2 are sliced by a blade, in particular at least sometimes simultaneously or at least sometimes sequentially. For this the device has for each food product an own track 7 along which it is transported in the direction of the blade 11. In each track is provided a gripper, which preferably is movable at least partially independently of the other grippers. Each gripper preferably has an ultrasonic sensor, which is connected to the control system and/or regulating system. Preferably, the ultrasonic sensors can be operated independently of one another, for instance with respect to the frequency at which signals are sent to the control/regulating system and/or the frequency and/or amplitude of the emitted ultrasonic waves.

### REFERENCE SYMBOL LIST

1 depositing table
2 food product
3 blade holder
4 support surface, transport means of a track 7
5 slicing device
6 cutting plane
7 track
8 gripper
9 cutter bar, cutting edge
10 gripping nippers
11 blade, cutting blade circular blade sickle blade
12 food slices
13 back of the food product
14 portion, food portion
15 contact surface for the back of the food product 2

1. A device for slicing a food product, in particular sausage, ham and or cheese, the device comprising:
a moving blade;
a track along which the food product is transported in a direction of a moving blade, which cuts off food slices from a front end of the food product, and
a gripper that grips a back of the food product before or during the food slices being cut off,
wherein the gripper has an ultrasonic sensor.

2.-10. (canceled)

11. The device as claimed in claim 1, wherein the ultrasonic sensor determines a distance between the gripper and the back of the food product.

12. The device as claimed in claim 1, wherein the device comprises a regulating system that receives a signal from the ultrasonic sensor and, in dependence on the signal, regulates a drive of the gripper.

13. The device as claimed in claim 1, wherein the device comprises a plurality of tracks, and in each of the tracks, and independently of other tracks, the food product is sliceable,
wherein each of the tracks has a gripper that is respectively engaged with a back of the food product and independently of other grippers.

14. The device as claimed in claim 1, wherein the ultrasonic sensor determines whether the gripper is in contact with the food product.

15. The device as claimed in claim 1, wherein the gripper has an ejector for a remnant of the food product, and
wherein in the ultrasonic sensor checks whether the remnant is ejected.

16. A method for slicing a food product with the device of claim 1, the method comprising
determining a distance between the gripper and the hack of the food product with the ultrasonic sensor, and
regulating a drive of the gripper with a regulating system in dependence on a signal from the ultrasonic sensor.

17. The method as claimed in claim 16, wherein on the basis of the signal from the ultrasonic sensor, it is determined whether the food product is present in the track.

18. The method as claimed in claim 16, wherein the method comprises:
slicing the food product, and
releasing a remnant of the food product from the gripper after the slicing,
wherein, on the basis of the signal from the ultrasonic sensor, it is determined whether the releasing has taken place.

19. The method as claimed in claim 16, wherein a position of the gripper after gripping of the food product is used to regulate a slicing of the food product.
